(19) United States
(12) Patent Application Publication
(10) Pub. No.: US 2026/0070242 A1
(43) Pub. Date: Mar. 12, 2026

(54) FOLDING KNIFE WITH FLASHLIGHTS

(71) Applicant: Shenzhen Aodao Technology Co., Ltd, Shenzhen (CN)

(72) Inventors: Liqiu XU, Yangchun (CN); Yangzong LAI, Ganzhou (CN)

(21) Appl. No.: 19/392,131

(22) Filed: Nov. 17, 2025

(30) Foreign Application Priority Data
Sep. 3, 2025 (CN) 2025218889860

(51) Int. Cl. B26B 11/00; F21V 7/04; F21Y 115/10

(52) U.S. Cl. CPC B26B 11/008; F21V 7/04; F21Y 2115/10

(57) ABSTRACT

A folding knife with flashlights, including a handle and a rotatable blade; the handle has two handle scales; the two handle scales are assembled with each other, and a receiving cavity for receiving the blade is formed between the two handle scales; a first receiving space is formed within the first handle scale, and a circuit board is installed within the first receiving space; a second receiving space is formed within the second handle scale, and a first battery electrically connected to the circuit board is installed within the second receiving space; two lighting components are installed at a first end and a second end of the handle respectively; both the two lighting components are electrically connected to the circuit board; a pivot end of the blade is located at the second end.

### TECHNICAL FIELD

The present invention pertains to the technical field of cutting tools, and more particularly, to a folding knife with flashlights.

### BACKGROUND OF THE INVENTION

As a common and practical portable tool, a folding knife is widely used in daily life, outdoor activities, and emergency situations due to its compact structure, ease of carrying, and flexible operation. With the growing popularity of outdoor recreational activities such as camping, hiking, and road trips, users' functional demands for folding knives have become increasingly diverse. In low-light or nighttime environments, users often require additional lighting equipment to assist with operations, for example, to clearly observe the blade's position and the working area when cutting objects, or for pathfinding and reviewing supplies in the dark. The traditional approach is to carry a folding knife and a flashlight separately, but this not only increases the carrying burden but also leads to problems of scattered equipment and inconvenient access.

Therefore, there is an urgent need for a folding knife with a flashlight that addresses both ambient lighting and localized lighting.

### BRIEF SUMMARY OF THE INVENTION

An objective of the present invention is to address the deficiencies of the prior art by providing a folding knife with flashlights that, while maintaining the original portability and operational comfort of a folding knife, also meets the needs for both ambient lighting and localized lighting, thereby enhancing the convenience of outdoor activities and the safety of knife operation.

To attain the above objective, the present invention provides the following technical solutions:

A folding knife with flashlights, comprising: a handle and a blade rotatably connected to one end of the handle; the handle comprises a first handle scale and a second handle scale; the first handle scale and the second handle scale are assembled with each other, and a receiving cavity is formed between the first handle scale and the second handle scale; the blade is rotatably received in the receiving cavity;

a first receiving space is formed within the first handle scale, and a circuit board is installed within the first receiving space;

a second receiving space is formed within the second handle scale, and a first battery, which is electrically connected to the circuit board, is installed within the second receiving space;

the handle is provided with a first lighting component and a second lighting component at a first end and a second end of the handle respectively along a longitudinal direction of the handle; both the first lighting component and the second lighting component are electrically connected to the circuit board; a pivot end of the blade is located at the second end.

Further, one side of the first handle scale is provided with a switch assembly connected to the circuit board for controlling the first lighting component and the second lighting component.

Further, the switch assembly comprises a knob rotatably disposed on said one side of the first handle scale; a magnet is provided in the knob; the circuit board is provided with at least two Hall switches that cooperate with the magnet; when the knob is rotated, the magnet triggers one of said at least two Hall switches when the magnet is rotated to a position above said one of said at least two Hall switches that enables a trigger signal to be transmitted, or triggers none of the said at least two Hall switches when the magnet is rotated to a position where no trigger signal is able to be generated with said at least two Hall switches.

Further, a bottom side of the knob is provided with a plurality of positioning grooves; said one side of the first handle scale is provided with a plurality of positioning balls that correspond to the plurality of positioning grooves; when the knob is rotated to a position where all the plurality of positioning balls correspond to all the plurality of positioning grooves, all the plurality of positioning balls fall into all the plurality of positioning grooves respectively.

Further, another side of the first handle scale is provided with a charging port; the circuit board is provided with a charging interface corresponding to the charging port.

Further, said another side of the first handle scale is also provided with a sliding groove; the charging port is located within the sliding groove; a sliding cover is installed within the sliding groove; the sliding cover is slidable within the sliding groove to expose or conceal the charging interface.

Further, the first handle scale is provided with a lighting component mounting groove at the first end of the handle; the first lighting component is installed within the lighting component mounting groove; the lighting component mounting groove is in communication with the first receiving space.

Further, the first lighting component comprises, installed sequentially from inside to outside of the lighting component mounting groove, an LED board, a centering piece, a reflector cup, a protective pad, a lens, and a retaining ring.

Further, the second lighting component comprises a light guide plate installed within the first receiving space and extending to the second end of the handle; the circuit board is provided with an LED bead, and the LED bead is disposed adjacent to the light guide plate.

Further, the first receiving space is also provided with a second battery that is electrically connected to the circuit board.

The beneficial effects of the present invention are as follows:

The present invention provides a folding knife with flashlights. By housing the circuit board and the first battery in the first handle scale and the second handle scale respectively, and by providing the first lighting component and the second lighting component at the first end and the second end of the handle respectively, lighting function is integrated with the folding knife, allowing the folding knife of the present invention to perform conventional cutting operations while also providing illumination in different directions. By adopting a non-contact switching method using the magnet and said at least two Hall switches, sealing performance of the product is enhanced, which is beneficial for dust and water resistance. Tactile operational feedback is provided through the cooperative engagement between the plurality of positioning balls and the plurality of positioning grooves. By providing the charging port and the sliding cover on said another side of the handle, entry of dust and other foreign matters is effectively prevented. By adopting a multi-layer structure including the LED board, the reflector cup, and the lens, light focusing is facilitated, improving illumination quality. By adding the second battery within the first receiving space, the total battery capacity of the present invention can be easily increased, enhancing its endurance. The present invention, while maintaining the original portability and operational comfort of a folding knife, meets the needs for both ambient lighting and localized lighting, thereby enhancing the convenience of outdoor activities and the safety of knife operation.

### BRIEF DESCRIPTION OF THE DRAWINGS

FIG. 1 is a structural schematic view of a folding knife of the present invention.

FIG. 2 is another structural schematic view of the folding knife of the present invention.

FIG. 3 is an exploded structural view of the folding knife of the present invention.

FIG. 4 is an exploded structural view of a first handle scale of the present invention.

FIG. 5 is a structural schematic view of a knob of the present invention.

FIG. 6 is an exploded structural view of a second handle scale of the present invention.

### List of Reference Numerals:

1: handle

110: first handle scale

111: first receiving space

112: positioning ball

113: charging port

114: sliding groove

115: sliding cover

116: lighting component mounting groove

117: first housing

118: first cover plate

119: shaped spring

120: second handle scale

121: second receiving space

122: second housing

123: second cover plate

130: receiving cavity

140: first end

150: second end

2: blade

3: circuit board

310: charging interface

4: first battery

5: first lighting component

510: LED board

520: centering piece

530: reflector cup

540: protective pad

550: lens

560: retaining ring

6: second lighting component

610: light guide plate

620: LED bead

7: switch assembly

710: knob

711: positioning groove

720: magnet

730: Hall switch

8: second battery

9: lock structure

10: pin header assembly

### DETAILED DESCRIPTION OF THE INVENTION

Embodiments of the present invention are described in detail below, and illustrative examples of said embodiments are shown in the accompanying drawings, wherein the same or similar reference numerals throughout the specification denote the same or similar elements or elements with the same or similar functions. The embodiments described below with reference to the drawings are exemplary and are intended to explain the present invention, and should not be construed as a limitation thereof.

In the description of the present invention, it is to be understood that the terms "length," "width," "upper," "lower," "front," "rear," "left," "right," "vertical," "horizontal," "top," "bottom," "inner," "outer," etc., indicate orientations or positional relationships based on the orientations or positional relationships shown in the drawings, and are merely for the convenience of describing the present invention and simplifying the description, and do not indicate or imply that the device or element referred to must have a specific orientation or be constructed and operated in a specific orientation, and therefore cannot be understood as a limitation on the present invention.

Furthermore, the terms "first" and "second" are used for descriptive purposes only and cannot be understood as indicating or implying relative importance or implicitly indicating the number of technical features indicated. Thus, a feature defined with "first" or "second" may explicitly or implicitly include one or more of that feature. In the description of the present invention, "a plurality of" means two or more, unless otherwise explicitly and specifically limited.

In the embodiments of the present invention, unless otherwise explicitly specified and limited, terms such as "install," "connect," "join," and "fix" should be understood in a broad sense. For example, a connection may be a fixed connection, a detachable connection, or an integral formation; it may be a mechanical connection or an electrical connection; it may be a direct connection or an indirect connection through an intermediary medium; it may be the internal communication between two elements or the interaction relationship between two elements. For those of ordinary skill in the art, the specific meanings of the above terms in the present invention can be understood according to the specific circumstances.

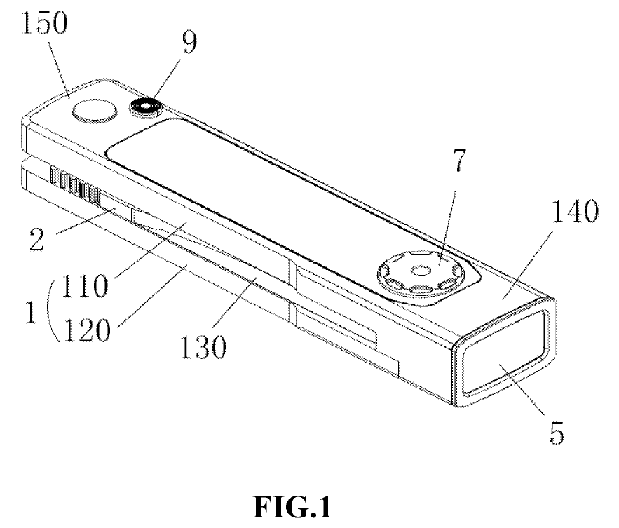

With reference to FIG. 1 through FIG. 6, a specific embodiment of a folding knife with flashlights provided by the present invention is shown.

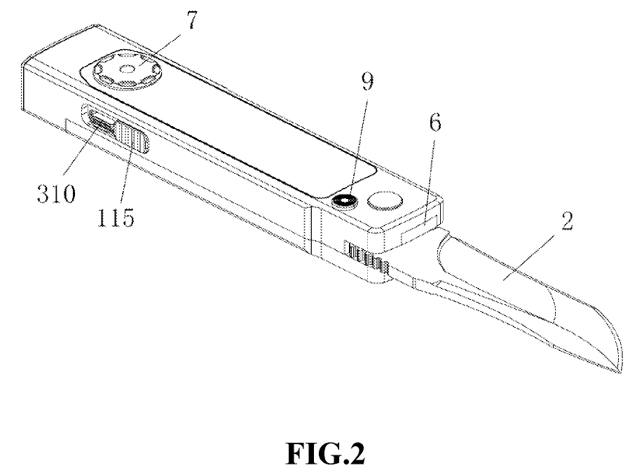

With reference to FIG. 1 and FIG. 2, a folding knife with flashlights comprises: a handle 1 and a blade 2 rotatably connected to one end of the handle 1. The handle 1 comprises a first handle scale 110 and a second handle scale 120. The first handle scale 110 and the second handle scale 120 are assembled with each other, and a receiving cavity 130 is formed between the first handle scale 110 and the second handle scale 120. The blade 2 is rotatably received in the receiving cavity 130.

A first receiving space 111 is formed within the first handle scale 110, and a circuit board 3 is installed within the first receiving space 111.

A second receiving space 121 is formed within the second handle scale 120, and a first battery 4, which is electrically connected to the circuit board 3, is installed within the second receiving space 121.

The handle 1 is provided with a first lighting component 5 and a second lighting component 6 at a first end 140 and a second end 150 of the handle 1 respectively along a longitudinal direction of the handle 1. Both the first lighting component 5 and the second lighting component 6 are electrically connected to the circuit board 3. A pivot end of the blade 2 is located at the second end 150.

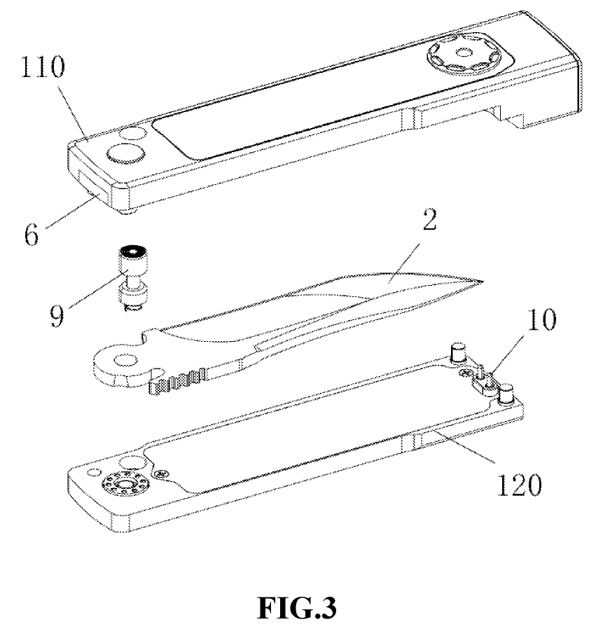

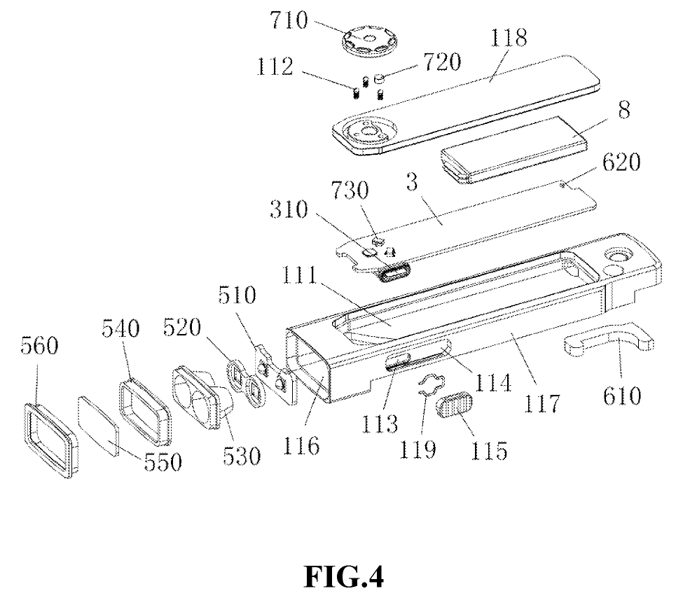

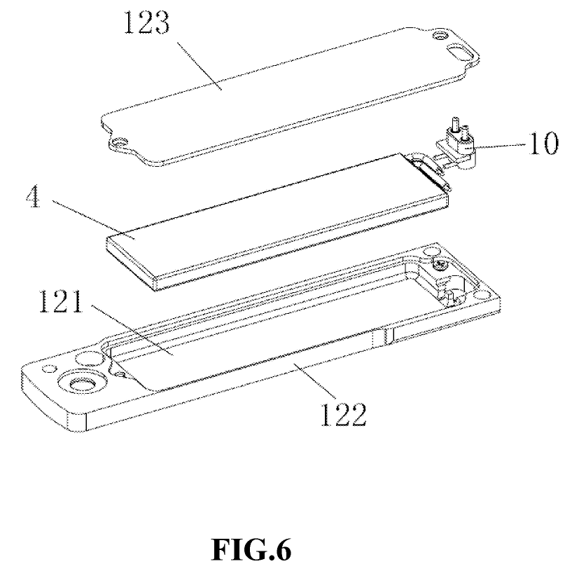

With reference to FIG. 4 and FIG. 6, in the above-described embodiment, by housing the circuit board 3 and the first battery 4 in the first handle scale 110 and the second handle scale 120 respectively, electronic components are integrated within the handle 1, making reasonable use of the space within the handle 1. By providing the first lighting component 5 and the second lighting component 6 at the two ends of the handle 1 along its longitudinal direction, the first lighting component 5, which is located away from the pivot end of the blade 2, can be used when ambient lighting is needed. When localized lighting is required for cutting objects, the second lighting component 6 can be used to illuminate the working area of the blade 2, greatly enhancing practicality and convenience in low-light environments. With reference to FIG. 3, in this embodiment, the handle 1 is also provided with a lock structure 9, which is used to limit rotation of the blade 2, preventing the blade 2 from accidentally rotating out or accidentally rotating during cutting. When the lock structure 9 is pressed, the blade 2 is in an unlocked state and can be rotated. When the blade 2 is fully opened or received within the receiving cavity 130, releasing the pressing force on the lock structure 9 causes the blade 2 to be fixed in a locked state, unable to be rotated.

With reference to FIG. 4, in the above-described embodiment, one side of the first handle scale 110 is provided with a switch assembly 7 connected to the circuit board 3, for controlling the first lighting component 5 and the second lighting component 6. In this embodiment, the first handle scale 110 comprises a first housing 117 and a first cover plate 118. The first receiving space 111 is formed within the first housing 117, and the first cover plate 118 covers the first receiving space 111. The switch assembly 7 is installed on the first cover plate 118. The second handle scale 120 comprises a second housing 122 and a second cover plate 123. The second receiving space 121 is formed within the second housing 122, and the second cover plate 123 covers the second receiving space 121. The first battery 4 is installed within the second receiving space 121.

With reference to FIG. 4, in the above-described embodiment, the switch assembly 7 comprises a knob 710 rotatably disposed on said one side of the first handle scale 110. A magnet 720 is provided in the knob 710. The circuit board 3 is provided with at least two Hall switches 730 that cooperate with the magnet 720. When the knob 710 is rotated, the magnet 720 will trigger one of said at least two Hall switches 730 when the magnet 720 is rotated to a position above said one of said at least two Hall switches 730 that enables a trigger signal to be transmitted, or will trigger none of the said at least two Hall switches 730 when the magnet 720 is rotated to a position where no trigger signal is able to be generated with said at least two Hall switches 730. In this embodiment, sensing and triggering of said at least two Hall switches 730 by the magnet 720 are achieved without any physical contact with said at least two Hall switches 730, thereby creating silent and wearing-free switching of electrical signals, making the switch control more durable and reliable, and also enhancing the sealing performance of the product, which is beneficial for dust and water resistance. In this embodiment, a rotation axis of the knob 710 can also be connected to a tactile button on the circuit board 3, enabling a press-to-start operation of the knob 710.

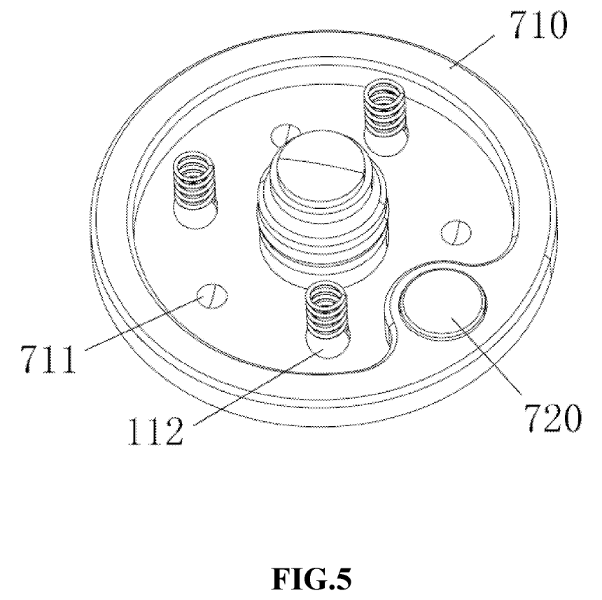

With reference to FIG. 4 and FIG. 5, in the above-described embodiment, a bottom side of the knob 710 is also provided with a plurality of positioning grooves 711. Said one side of the first handle scale 110 is provided with a plurality of positioning balls 112 that correspond to the plurality of positioning grooves 711. When the knob 710 is rotated to a position where all the plurality of positioning balls 112 correspond to all the plurality of positioning grooves 711, all the plurality of positioning balls 112 fall into all the plurality of positioning grooves 711 respectively. In this embodiment, the cooperative engagement between the plurality of positioning balls 112 and the plurality of positioning grooves 711 allows the knob 710 to produce a clear tactile feedback and automatically lock into position when rotated to a specific position. This allows the user to accurately identify and confirm the current switch state by tactile feeling, thereby preventing erroneous operation.

With reference to FIG. 4, in the above-described embodiment, another side of the first handle scale 110 is provided with a charging port 113. The circuit board 3 is provided with a charging interface 310 corresponding to the charging port 113. In this embodiment, the charging port 113 on said another side of the handle 1 allows for the charging of built-in batteries (i.e. said first battery 4 and a second battery 8 that will be described later) via a charging cable. In this embodiment, the charging interface 310 can be a Type-C interface, a magnetic interface, or the like.

With reference to FIG. 4, in the above-described embodiment, said another side of the first handle scale 110 is also provided with a sliding groove 114. The charging port 113 is located within the sliding groove 114. A sliding cover 115 is installed within the sliding groove 114. The sliding cover 115 is slidable within the sliding groove 114 to expose or conceal the charging interface 310. In this embodiment, when not charging, the charging interface 310 can be concealed by the sliding cover 115, preventing dust, moisture, and other foreign matters from contaminating the charging interface 310. In this embodiment, a shaped spring 119 is disposed between the sliding cover 115 and an inner wall of the sliding groove 114 to position the sliding cover 115 in either the state of exposing or concealing the charging interface 310.

With reference to FIG. 4, in the above-described embodiment, the first handle scale 110 is provided with a lighting component mounting groove 116 at the first end 140 of the handle 1. The first lighting component 5 is installed within the lighting component mounting groove 116. The lighting component mounting groove 116 is in communication with the first receiving space 111. In this embodiment, the lighting component mounting groove 116 serves to centralize the installation, positioning, and heat dissipation of the first lighting component 5, ensuring the stability and reliability of the illumination from a direction where light comes out from the first end 140. In this embodiment, a pin header assembly 10 is provided between the first handle scale 110 and the second handle scale 120 at a position corresponding to the lighting component mounting groove 116 to achieve electrical connection between the first battery 4 and the circuit board 3.

With reference to FIG. 4, in the above-described embodiment, the first lighting component 5 comprises, installed sequentially from inside to outside of the lighting component mounting groove 116, an LED board 510, a centering piece 520, a reflector cup 530, a protective pad 540, a lens 550, and a retaining ring 560. In this embodiment, the LED board 510 has a dual-bead structure. The centering piece 520 is used to accurately position the reflector cup 530 over the two light beads of the LED board 510. Light is reflected by the reflector cup 530 and then emitted through the lens 550, enabling the first lighting component 5 to produce a focused, bright light spot that meets usage requirements, thereby improving illumination quality.

With reference to FIG. 4, in the above-described embodiment, the second lighting component 6 comprises a light guide plate 610 installed within the first receiving space 111 and extending to the second end 150 of the handle 1. The circuit board 3 is provided with an LED bead 620, and the LED bead 620 is disposed adjacent to the light guide plate 610. In this embodiment, by providing the LED bead 620 on the circuit board 3 and using the light guide plate 610 to conduct light to the second end 150, a small-area, low-power auxiliary illumination or signal light source is formed at a front end of the handle 1. This facilitates close-range illumination for the blade's working area while saving space and cost.

With reference to FIG. 4, in the above-described embodiment, the first receiving space 111 is also provided with a second battery 8 that is electrically connected to the circuit board 3. In this embodiment, the addition of the second battery 8 is beneficial for increasing the total battery capacity of the present invention, effectively extending the continuous use of the lighting components, and enhancing the product's endurance, making it more suitable for long-duration use, such as during outdoor activities. When the charging cable is connected to the charging interface 310 for charging, both the first battery 4 and the second battery 8 will be charged simultaneously.

In summary, the present invention provides a folding knife with flashlights. By housing the circuit board 3 and the first battery 4 in the first handle scale 110 and the second handle scale 120 respectively, and by providing the first lighting component 5 and the second lighting component 6 at the first end and the second end of the handle 1 respectively, lighting function is integrated with the folding knife, allowing the folding knife of the present invention to perform conventional cutting operations while also providing illumination in different directions. By adopting a non-contact switching method using the magnet 720 and said at least two Hall switches 730, sealing performance of the product is enhanced, which is beneficial for dust and water resistance. Tactile operational feedback is provided through the cooperative engagement between the plurality of positioning balls 112 and the plurality of positioning grooves 711. By providing the charging port 113 and the sliding cover 115 on said another side of the handle 1, entry of dust and other foreign matters is effectively prevented. By adopting a multi-layer structure including the LED board 510, the reflector cup 530, and the lens 550, light focusing is facilitated, improving illumination quality. By adding the second battery 8 within the first receiving space 111, the total battery capacity of the present invention can be easily increased, enhancing its endurance. The present invention, while maintaining the original portability and operational comfort of a folding knife, meets the needs for both ambient lighting and localized lighting, thereby enhancing the convenience of outdoor activities and the safety of knife operation.

The above-described embodiments are only some of the preferred specific implementations of the present invention. Common and non-inventive variations and substitutions made by a person skilled in the art within the technical scope of the present invention should be included within the protection scope of the present invention.

1. A folding knife, comprising:
a handle and a blade rotatably connected to one end of the handle; the handle comprises a first handle scale and a second handle scale; the first handle scale and the second handle scale are assembled with each other, and a receiving cavity is formed between the first handle scale and the second handle scale; the blade is rotatably received in the receiving cavity;
a first receiving space is formed within the first handle scale, and a circuit board is installed within the first receiving space;
a second receiving space is formed within the second handle scale, and a first battery, which is electrically connected to the circuit board, is installed within the second receiving space;
the handle is provided with a first lighting component and a second lighting component at a first end and a second end of the handle respectively along a longitudinal direction of the handle; both the first lighting component and the second lighting component are electrically connected to the circuit board; a pivot end of the blade is located at the second end.

2. The folding knife of claim 1, wherein one side of the first handle scale is provided with a switch assembly connected to the circuit board for controlling the first lighting component and the second lighting component.

3. The folding knife of claim 2, wherein the switch assembly comprises a knob rotatably disposed on said one side of the first handle scale; a magnet is provided in the knob; the circuit board is provided with at least two Hall switches that cooperate with the magnet.

4. The folding knife of claim 3, wherein a bottom side of the knob is provided with a plurality of positioning grooves; said one side of the first handle scale is provided with a plurality of positioning balls that correspond to the plurality of positioning grooves.

5. The folding knife of claim 1, wherein another side of the first handle scale is provided with a charging port; the circuit board is provided with a charging interface corresponding to the charging port.

6. The folding knife of claim 5, wherein said another side of the first handle scale is also provided with a sliding groove; the charging port is located within the sliding groove; a sliding cover is installed within the sliding groove; the sliding cover is slidable within the sliding groove to expose or conceal the charging interface.

7. The folding knife of claim 1, wherein the first handle scale is provided with a lighting component mounting groove at the first end of the handle; the first lighting component is installed within the lighting component mounting groove; the lighting component mounting groove is in communication with the first receiving space.

8. The folding knife of claim 7, wherein the first lighting component comprises, installed sequentially from inside to outside of the lighting component mounting groove, an LED board, a centering piece, a reflector cup, a protective pad, a lens, and a retaining ring.

9. The folding knife of claim 1, wherein the second lighting component comprises a light guide plate installed within the first receiving space; the circuit board is provided with an LED bead.

10. The folding knife of claim 1, wherein the first receiving space is also provided with a second battery that is electrically connected to the circuit board.
